(19) United States
(12) Patent Application Publication
(10) Pub. No.: US 2014/0153128 A1
(43) Pub. Date: Jun. 5, 2014

(54) MAGNETIC RECORDING MEDIUM, METHOD OF MANUFACTURING THE SAME, AND MAGNETIC RECORDING/REPRODUCTION APPARATUS

(71) Applicant: KABUSHIKI KAISHA TOSHIBA, Tokyo (JP)

(72) Inventors: Hironori TEGURI, Yamato-shi (JP); Akira WATANABE, Kawasaki-shi (JP); Tomoko TAGUCHI, Kunitachi-shi (JP)

(73) Assignee: KABUSHIKI KAISHA TOSHIBA, Tokyo (JP)

(21) Appl. No.: 13/793,409

(22) Filed: Mar. 11, 2013

(30) Foreign Application Priority Data
Nov. 30, 2012 (JP) 2012-263611

(51) Int. Cl. G11B 5/738; G11B 5/02; G11B 5/851; G11B 5/65; G11B 5/66

(52) U.S. Cl. CPC G11B 5/738; G11B 5/653; G11B 5/656; G11B 5/66; G11B 5/851; G11B 5/02
USPC 360/59; 428/836.1; 428/832; 428/831; 204/192.2

(57) ABSTRACT

According to one embodiment, a magnetic recording medium includes a magnetic recording layer formed on a substrate and including magnetic grains and a grain boundary formed between the magnetic grains, the grain boundary includes a first grain boundary having a first thermal conductivity, and a second grain boundary formed on the first grain boundary and having a second thermal conductivity different from the first thermal conductivity, and at least one of the first and second grain boundaries suppresses thermal conduction.

### CROSS-REFERENCE TO RELATED APPLICATIONS

This application is based upon and claims the benefit of priority from Japanese Patent Application No. 2012-263611, filed Nov. 30, 2012, the entire contents of which are incorporated herein by reference.

### FIELD

Embodiments described herein relate generally to a magnetic recording medium, a method of manufacturing the same, and a magnetic recording/reproduction apparatus.

### BACKGROUND

A magnetic recording apparatus for magnetically recording and reproducing information has been developed as a large-capacity, high-speed, and inexpensive information storage means. In particular, the recent increase of recording capacity of a hard disk drive (HDD) is significant. The recording density of the HDD has been increased as a compilation of a plurality of element techniques such as signal processing, mechanical servo, a head, a medium, and a head-disk interface (HDI). Recently, however, the thermal disturbance of the medium is becoming obvious as a primary factor that makes it difficult to increase the recording density of the HDD.

In magnetic recording using a conventional many-grains-system medium including a thin polycrystalline magnetic grain film, noise reduction and securement of thermal stability and recording sensitivity have a tradeoff relationship, and this is a main cause that determines the limit of the recording density.

When a magnetic anisotropy constant Ku of the magnetic recording film of medium is increased in order to achieve both a small grain size and a high thermal stability, a recording coercive force Hc0 of the medium rises. Hc0 is the coercive force when a magnetic head performs high-speed magnetization reversal. A magnetic field necessary for saturation recording increases in proportion to Hc0.

By contrast, if the medium is locally heated by some means, it is possible to decrease the Hc0 of the heated portion and improve the overwrite (OW) characteristic.

A thermally assisted magnetic recording method is an example of this method.

In a thermally assisted magnetic recording method using the many-grains-system medium, it is desirable to use fine magnetic grains that sufficiently reduce noise, and use a recording layer having a high Ku at near room temperature in order to ensure the thermal stability. A medium having a high Ku as described above is not recordable at near room temperature because the magnetic field necessary for recording is larger than a magnetic field generated by a recording head. In the thermally assisted magnetic recording method, however, a heating means using a light beam or the like is placed near a recording magnetic pole, and recording can be performed by locally heating the medium and making the Hc0 of the heated portion lower than that of the recording magnetic field from a head.

To further increase the recording density of this thermally assisted magnetic recording, demands have arisen for a high medium SNR and the suppression of deterioration of recorded information caused by thermal spread between magnetic grains.

### BRIEF DESCRIPTION OF THE DRAWINGS

FIG. 1 is a sectional view showing a magnetic recording medium according to Example 1;

FIGS. 2A, 2B, 2C, 2D, and 2E are views showing an example of a method of manufacturing the magnetic recording medium shown in FIG. 1;

FIGS. 3A and 3B are graphs showing relationship between track widthwise direction and error rate of a recording signal of the magnetic recording medium;

FIG. 4 is a sectional view showing a magnetic recording medium according to Example 2;

FIGS. 5A, 5B, 5C, 5D, and 5E are views showing an example of a method of manufacturing the magnetic recording medium shown in FIG. 4;

FIG. 6 is a sectional view showing a magnetic recording medium according to Example 3;

FIGS. 7A, 7B, 7C, 7D, and 7E are views showing an example of a method of manufacturing the magnetic recording medium of Example 3;

FIG. 8 is a sectional view showing a magnetic recording medium according to Example 4;

FIGS. 9A, 9B, 9C, 9D, and 9E are views showing an example of a method of manufacturing the magnetic recording medium of Example 4;

FIG. 10 is a sectional view showing a magnetic recording medium according to Example 5;

FIGS. 11A, 11B, 11C, 11D, and 11E are views showing an example of a method of manufacturing the magnetic recording medium of Example 5;

FIG. 12 is a partially exploded perspective view showing an example of a magnetic recording/reproduction apparatus to which the magnetic recording medium is applicable;

FIG. 13 is a view showing an arrangement in the periphery of a magnetic head shown in FIG. 12;

FIG. 14 is a graph showing relationship between distance from a laser source and temperature of the magnetic recording medium;

FIG. 15 is a sectional view showing a magnetic recording medium according to Example 7; and

FIG. 16 is a sectional view showing a magnetic recording medium according to Example 8.

### DETAILED DESCRIPTION

In general, according to one embodiment, a magnetic recording medium includes a substrate, and a magnetic recording layer formed on the substrate and having a granular structure including magnetic grains and a grain boundary formed between the magnetic grains. The grain boundary includes a first grain boundary, and a second grain boundary formed on the first grain boundary. The first grain boundary has a first thermal conductivity. The second grain boundary has a second thermal conductivity different from the first thermal conductivity. In addition, at least one of the first and second grain boundaries suppresses thermal conduction.

Also, a method of manufacturing the magnetic recording medium according to the embodiment includes a step of forming, on a substrate, a magnetic recording layer including magnetic grains and a grain boundary formed between the magnetic grains and made of a first material, and a step of forming a trench by removing at least a portion of the grain boundary, and forming, on the trench, a layer made of a second material having a thermal conductivity lower than that of the first material, thereby forming a structure in which the grain boundary is divided into a first grain boundary having a first thermal conductivity and a second grain boundary having a second thermal conductivity different from the first thermal conductivity, and at least one of the first and second grain boundaries suppresses thermal conduction.

According to the embodiment, the structure in which the grain boundary is divided into the first and second grain boundaries and at least one of them suppresses thermal conduction is formed. This can achieve an effect of suppressing thermal spread in the recording track widthwise direction and circumferential direction. In magnetic recording using the thermally assisted recording method, therefore, it is possible to suppress deterioration of recorded information caused by thermal spread between the magnetic grains and obtain a high medium SNR at the same time.

In the magnetic recording medium according to the embodiment, a heat-sink layer can further be formed between the substrate and magnetic recording layer.

The heat-sink layer contains at least one material selected from the group consisting of Ag, Cu, Au, and their alloys.

It is possible to further form a thermal barrier layer between the heat-sink layer and magnetic recording layer.

The thermal barrier layer contains ZrO₂.

The magnetic grains can be selected from the group consisting of an FePt alloy having an L1₀ structure, a CoPt alloy having the L1₀ structure, and a Co/Pt multilayered film.

The above-mentioned magnetic grains can be formed by sputtering, for example, an FePt—C target or a Co target, Pt target, and C target.

Each of the first and second grain boundaries is selected from a layer made of at least one material selected from the group consisting of carbon, SiO₂, TiO₂, and Cr₂O₃, and an air gap defined by this layer and/or the magnetic grains.

The thermal conductivity of carbon is 100 to 2,000 W/(mK), that of SiO₂ is 1 to 10 W/(mK), that of TiO₂ is 1 to 10 W/(mK), and that of Cr₂O₃ is 1 to 10 W/(mK).

The magnetic recording medium according to the embodiment can further include a third grain boundary on the second grain boundary.

The third grain boundary can also be selected from a layer made of at least one material selected from the group consisting of carbon, SiO₂, TiO₂, and Cr₂O₃, and an air gap defined by this layer and/or the magnetic grains.

In the method of manufacturing the magnetic recording medium according to the embodiment, it is possible to use carbon as the first material, and one of SiO₂ and TiO₂ as the second material.

### EXAMPLES

The embodiment will be explained in more detail below with reference to the accompanying drawings.

### Example 1

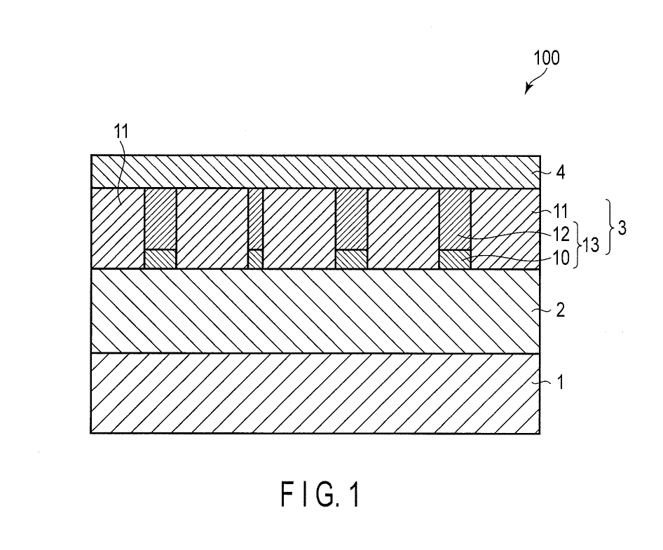

FIG. 1 is a sectional view showing a magnetic recording medium according to Example 1.

As shown in FIG. 1, a magnetic recording medium 100 is a magnetic recording medium to be incorporated into a magnetic disk apparatus for thermally assisted recording, and includes a glass substrate 1, and an MgO underlayer 2, magnetic recording layer 3, and diamond-like carbon (DLC) protective film 4 sequentially formed on the glass substrate 1.

The magnetic recording layer 3 includes magnetic grains 11 made of an FePt alloy having a high magnetic anisotropy, and a grain boundary 13 formed between the magnetic grains 11. The grain boundary 13 includes a first grain boundary 10 formed by a carbon (C) layer, and a second grain boundary 12 formed on the first grain boundary 10 by using an SiO₂ layer and having a low thermal conductivity.

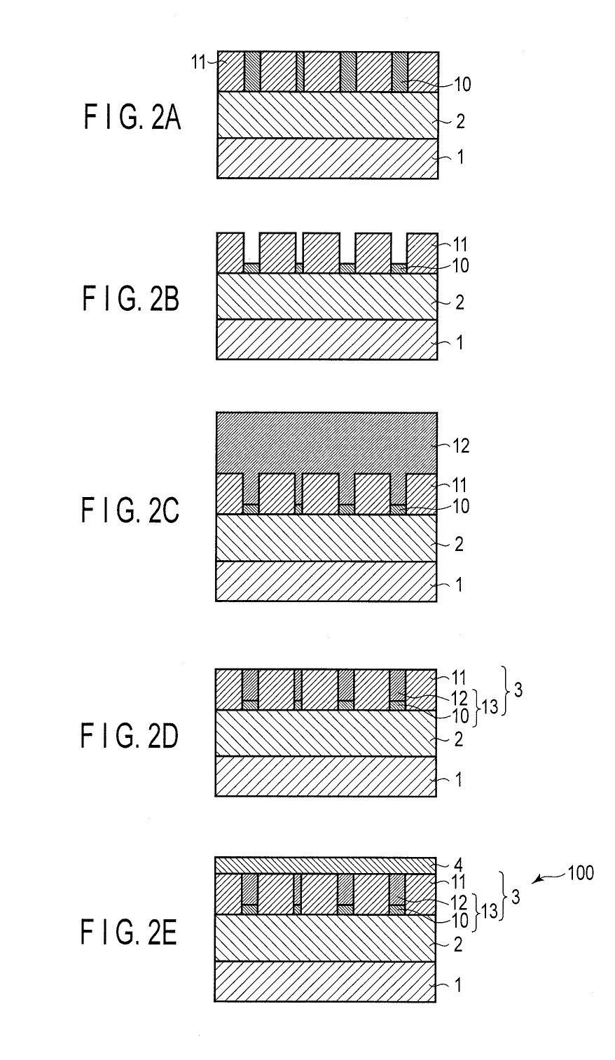

FIGS. 2A, 2B, 2C, 2D, and 2E are views showing an example of a method of manufacturing the magnetic recording medium shown in FIG. 1.

First, as shown in FIG. 2A, a 10-nm-thick MgO underlayer 2 is deposited on a glass substrate 1 by sputtering at an Ar gas pressure of 1 Pa and an RF power of 800 W. While the substrate is heated to 500° C., a 6-nm-thick FePt—C magnetic recording layer is deposited on the substrate by sputtering by using an FePt—C composite target at an Ar gas pressure of 1 Pa and a DC power of 1,000 W. The obtained magnetic recording layer has a granular structure including FePt magnetic grains 11 and a carbon (C) grain boundary 10 formed between the magnetic grains 11.

Then, as shown in FIG. 2B, the upper portion of the grain boundary formed by the C layer 10 is removed by etching, thereby forming a trench above the grain boundary. The upper portion of the C layer 10 can be removed by, for example, etching using oxygen plasma. More specifically, reactive ion etching (RIE) is performed for 20 seconds at an oxygen flow rate of 20 sccm, a total pressure of 0.1 Pa, an RF power of 100 W, and a platen power of 10 W.

Subsequently, as shown in FIG. 2C, a 16-nm-thick SiO₂ layer 12 is formed on the magnetic grains 11 by performing sputtering for 2 minutes by using SiO₂ as a target at a total pressure of 1 Pa and an RF power of 100 W. An oxide such as TiO₂ can also be used instead of SiO₂. Consequently, the SiO₂ layer is also filled in the trench above the C layer 10 in the grain boundary.

As shown in FIG. 2D, a planarizing process is performed by etching so as to level the upper surfaces of the SiO₂ film 12 and magnetic grains 11. For example, RIE is performed for 10 seconds by using gaseous CF₄ at a total pressure of 5 Pa and an RP power of 80 W. Consequently, a grain boundary 13 including the C layer 10 and SiO₂ film 12 is formed.

As shown in FIG. 2E, a 5-nm-thick DLC protective film 4 is formed on the magnetic recording layer 3 including the grain boundary 13 and magnetic grains 11 by sputtering at an Ar gas pressure of 1 Pa and a DC power of 1,000 W, thereby obtaining a magnetic recording medium 100 according to Example 1.

The thermal conductivity of carbon (C) is about 100 to 2,000, and that of SiO₂ is about 1 to 10. Therefore, in the embodiment in which the grain boundary including the C layer and SiO₂ film is formed, the thermal spread suppression effect in the recording track widthwise direction and circumferential direction improves with respect to the FePt—C medium.

When thermal spread is suppressed in the track circumferential direction, the thermal change (thermal gradient) in the circumferential direction becomes steep. In information recording on a magnetic recording medium, a steep thermal gradient achieves an effect of reducing the magnetization transition width. That is, the reduction in magnetization transition width has an effect of increasing the medium SNR.

Thermal spread is also suppressed in the track widthwise direction. During recording information on a recording track, this brings an effect of reducing the influence which a magnetic field or near-field light generated from a recording head has on adjacent tracks.

A medium SNR of the FePt—C medium is relatively higher than that of a medium formed by sputtering Fe, Pt, and an oxide such as SiO₂. Therefore, in the embodiment using the magnetic grains of the FePt—C medium, a much higher medium SNR is obtained.

In the magnetic recording medium according to Example 1 as described above, a nonmagnetic material having a low thermal conductivity is formed after C is removed from between the magnetic grains of the FePt—C medium by which a relatively high medium SNR is obtained. This makes it possible to achieve the effect of suppressing thermal spread in the recording track widthwise direction and circumferential direction. Consequently, it is possible to further increase the medium SNR, and suppress deterioration of recorded information in the recording track widthwise direction.

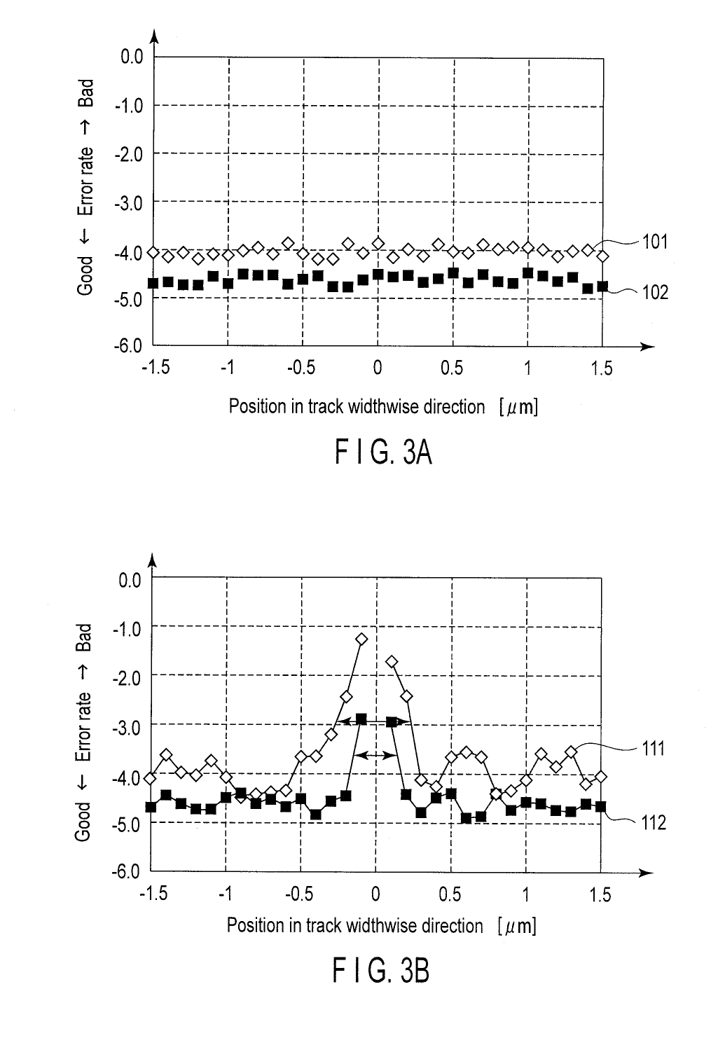

FIGS. 3A and 3B are graphs showing the relationship between the track widthwise direction and error rate of a recording signal of the magnetic recording medium according to the embodiment.

FIG. 3A shows recording signal error rate track profiles when thermally assisted recording was performed using the magnetic recording medium of Example 1 and a magnetic recording medium of Comparative Example 1.

The magnetic recording medium of Comparative Example 1 was formed following the same procedures as in Example 1 except that the upper portion of the grain boundary formed by the C layer 10 was not removed, and no SiO₂ layer was formed.

FIG. 3A shows the relationship between the position in the track widthwise direction and the recording signal error rate obtained on the track when initial recording was performed on a plurality of recording tracks at a track pitch of 100 nm. Reference numeral 101 denotes data obtained when using the magnetic recording medium for comparison; and 102, data obtained when using the magnetic recording medium according to the embodiment. As shown in FIG. 3A, the error rate was decreased, i.e., improved when using the magnetic recording medium according to the embodiment. This is probably because thermal spread was suppressed in the track circumferential direction as described previously.

FIG. 3B shows error rate track profiles obtained when recording was performed 1,000 times at a position of 0 μm in the measurement track widthwise direction by using a signal pattern different from that of the above-mentioned initial recording, after the error rate track profiles shown in FIG. 3A were measured. Reference numeral 111 denotes data obtained when using the magnetic recording medium for comparison; and 112, data obtained when using the magnetic recording medium according to the embodiment.

As shown in FIG. 3B, the error rate deterioration width was decreased, i.e., improved when using the magnetic recording medium according to the embodiment. This is assumed to be because thermal spread was suppressed in the track widthwise direction as described previously.

### Example 2

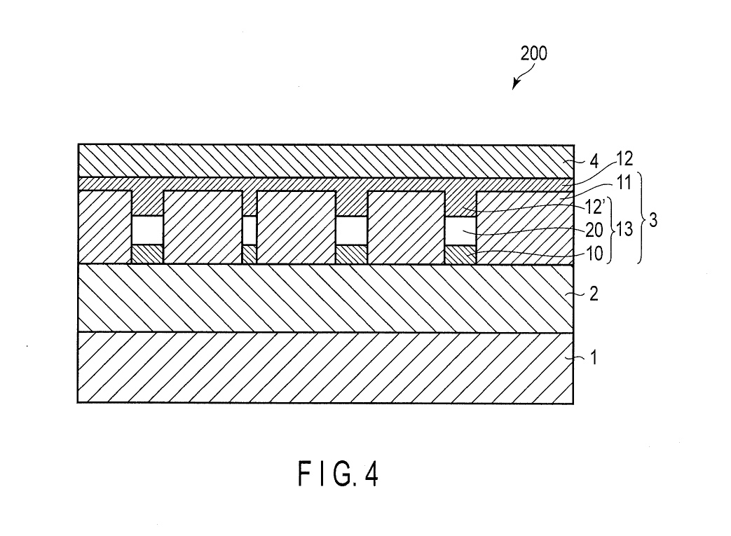

FIG. 4 is a sectional view showing a magnetic recording medium according to Example 2.

A magnetic recording medium 200 according to Example 2 includes a glass substrate 1, and an MgO underlayer 2, magnetic recording layer 3, SiO₂ layer 12, and DLC protective film 4 sequentially formed on the glass substrate 1.

The magnetic recording, layer 3 includes magnetic grains 11 made of an FePt alloy having a high magnetic anisotropy, and a grain boundary 13 formed between the magnetic grains 11.

The grain boundary 13 includes a first grain boundary 10 formed by a C layer, an air gap 20 formed on the first grain boundary, and an SiO₂ layer 12′ formed on the air gap 20 and having a low thermal conductivity. Note that the SiO₂ layer 12 is formed on the air gap 20 and magnetic grains 11 so as to close the air gap 20.

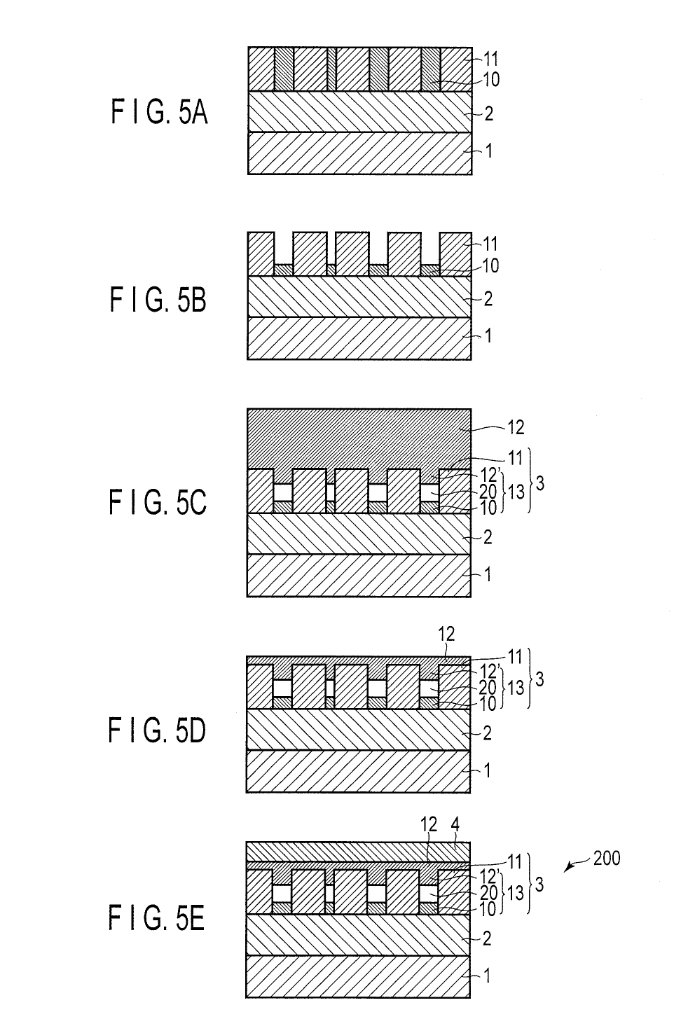

FIGS. 5A, 5B, 5C, 5D, and 5E are views showing an example of a method of manufacturing the magnetic recording medium of Example 2.

As shown in FIG. 5A, a 10-nm-thick MgO underlayer 2 is deposited on a glass substrate 1 by sputtering at an Ar gas pressure of 1 Pa and an RF power of 800 W. While the substrate is heated to 500° C., a 6-nm-thick FePt—C magnetic recording layer is deposited on the substrate by sputtering by using Fe, Pt, and C targets at an Ar gas pressure of 1 Pa and a DC power of 1,000 W. The obtained magnetic recording layer has a granular structure including FePt magnetic grains 11 and a grain boundary formed by a C layer 10 between the magnetic grains 11.

Then, as shown in FIG. 5B, the upper portion of the C layer 10 is removed by etching, thereby forming a trench above the grain boundary. The upper portion of the C layer 10 can be removed by, for example, etching using oxygen plasma. More specifically, reactive ion etching (RIE) is performed for 20 seconds at an oxygen flow rate of 20 sccm, a total pressure of 0.1 Pa, an RF power of 100 W, and a platen power of 10 W.

Subsequently, as shown in FIG. 5C, a 50-nm-thick spin-on-glass (SOG) layer 12 is deposited on the magnetic grains 11 by spin coating by using a hydrogen silsesquioxane polymer (HSQ) having a molecular weight of 5,000 to 50,000. Since SOG having a relatively large molecular weight is used, an air gap 20 is formed between the C layer 10 and SOG layer 12. Consequently, a grain boundary 13 has the C layer 10, the air gap 20 formed on the C layer 10, and a portion 12′ of the SOG layer buried on the air gap 20. A magnetic recording layer 3 is obtained by the grain boundary 13 and magnetic grains 11.

As shown in FIG. 5D, etching is so performed as to level the upper surface of the SOG layer 12 and leave a 2-nm-thick layer behind on the FePt magnetic grains 11. For example, a planarizing/thinning process is performed by performing RIE for 8 minutes by using gaseous CF₄ at a total pressure of 5 Pa and an RP power of 80 W.

After that, as shown in FIG. 5E, a 5-nm-thick DLC protective film 4 is formed on the SOG layer 12 by sputtering at an Ar gas pressure of 1 Pa and a DC power of 1,000 W, thereby obtaining a magnetic recording medium 200 according to Example 2.

The thermal conductivity of C is about 100 to 2,000, and that of a gas is about 0.02. Therefore, the thermal spread suppression effect in the recording track widthwise direction and circumferential direction improves with respect to the FePt—C medium.

### Example 3

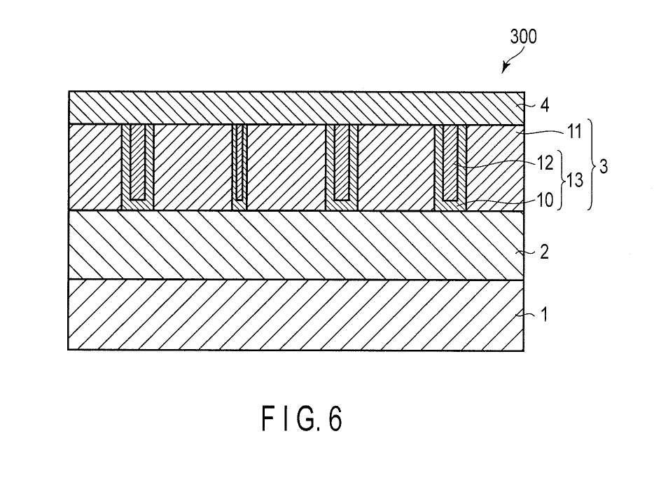

FIG. 6 is a sectional view showing a magnetic recording medium according to Example 3.

A magnetic recording medium 300 according to Example 3 includes a glass substrate 1, and an MgO underlayer 2, magnetic recording layer 3, and DLC protective film 4 sequentially formed on the glass substrate 1.

The magnetic recording layer 3 includes magnetic grains 11 made of an FePt alloy having a high magnetic anisotropy, and a grain boundary 13 formed between the magnetic grains 11.

In the grain boundary 13, a C layer 10 is formed from the lower portion to the side surfaces of the magnetic grains 11, and an SiO₂ layer 12 having a low thermal conductivity is formed in a trench surrounded by the C layer 10.

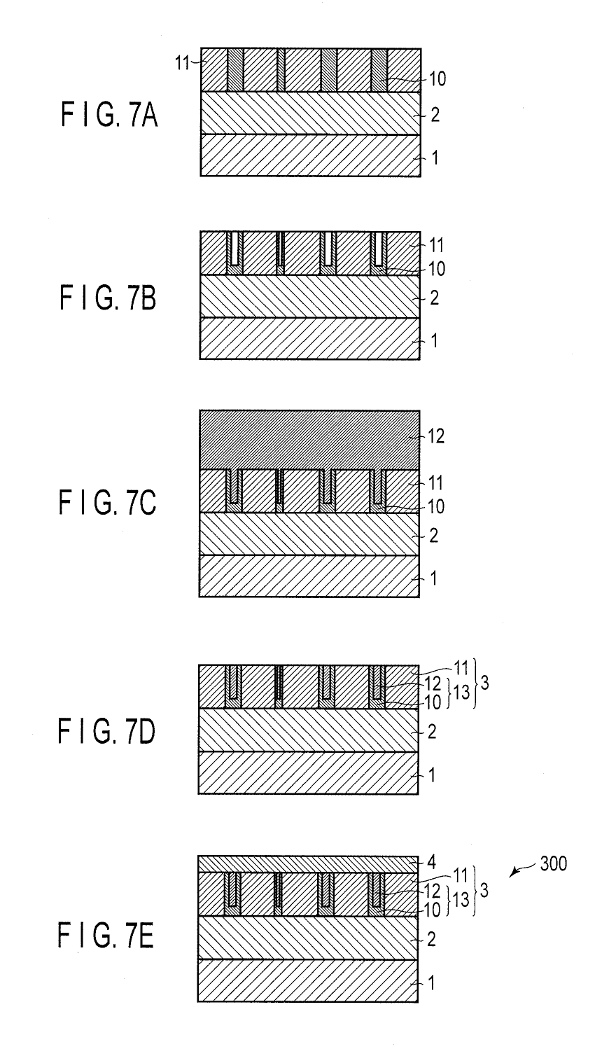

FIGS. 7A, 7B, 7C, 7D, and 7E are views showing an example of a method of manufacturing the magnetic recording medium of Example 3.

First, as shown in FIG. 7A, a 10-nm-thick MgO underlayer 2 is deposited on a glass substrate 1 by sputtering at an Ar gas pressure of 1 Pa and an RF power of 800 W. While the substrate is heated to 500° C., a 6-nm-thick FePt—C magnetic recording layer is deposited on the substrate by sputtering by using an FePt—C composite target at an Ar gas pressure of 1 Pa and a DC power of 1,000 W. The obtained magnetic recording layer has a granular structure including FePt magnetic grains 11 and a grain boundary formed between the magnetic grains 11 and made of carbon (C) 10.

Then, as shown in FIG. 7B, the grain boundary formed by the C layer 10 is partially removed by etching. The C layer 10 can partially be removed by, for example, etching using oxygen plasma. More specifically, RIE is performed for 10 seconds at an oxygen flow rate of 10 sccm, a total pressure of 0.1 Pa, an RF power of 100 W, and a platen power of 10 W. Consequently, the C layer 10 remains from the lower portion of the grain boundary to the side surfaces of the magnetic grains 11, and the interior of the C layer 10 is removed, thereby forming a trench.

Subsequently, as shown in FIG. 7C, an SiO₂ layer 12 is formed in the trench and on the magnetic grains 11 by performing sputtering for 2 minutes by using SiO₂ as a target at a total pressure of 1 Pa and an RF power of 100 W. An oxide such as TiO₂ can also be used instead of SiO₂. Consequently, the SiO₂ layer is also filled in the trench in the grain boundary.

As shown in FIG. 7D, a planarizing process is performed by etching so as to level the upper surfaces of the SiO₂ film 12 and magnetic grains 11. For example, RIE is performed for 10 minutes by using gaseous CF₄ at a total pressure of 5 Pa and an RP power of 80 W. Consequently, a grain boundary 13 including the C layer 10 formed from the lower portion of the grain boundary to the side surfaces and the SiO₂ layer 12 filled in the C layer 10 is formed.

As shown in FIG. 7E, a DLC protective film 4 is formed on the magnetic recording layer 3 including the grain boundary 13 and magnetic grains 11 by sputtering, thereby obtaining a magnetic recording medium 300 according to Example 3.

### Example 4

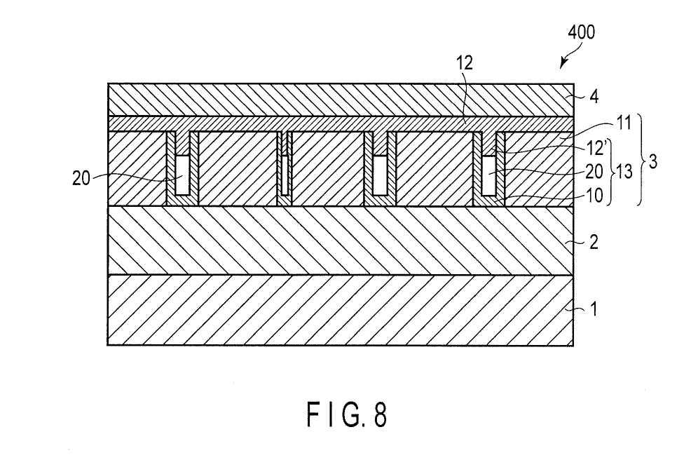

FIG. 8 is a sectional view showing a magnetic recording medium according to Example 4.

A magnetic recording medium 400 according to Example 4 includes a glass substrate 1, and an MgO underlayer 2, magnetic recording layer 3, SiO₂ layer 12, and DLC protective film 4 sequentially formed on the glass substrate 1.

The magnetic recording layer 3 includes magnetic grains 11 made of an FePt alloy having a high magnetic anisotropy, and a grain boundary 13 formed between the magnetic grains 11.

The grain boundary 13 includes a C layer 10 formed from the lower portion to the side surfaces of the magnetic grains 11, an air gap 20 formed in the lower portion of the trench surrounded by the C layer 10, and an SiO₂ layer 12′ formed on the air gap 20 and having a low thermal conductivity. Note that the SiO₂ layer 12 is formed on the air gap 20 and magnetic recording layer 3 so as to close the air gap 20.

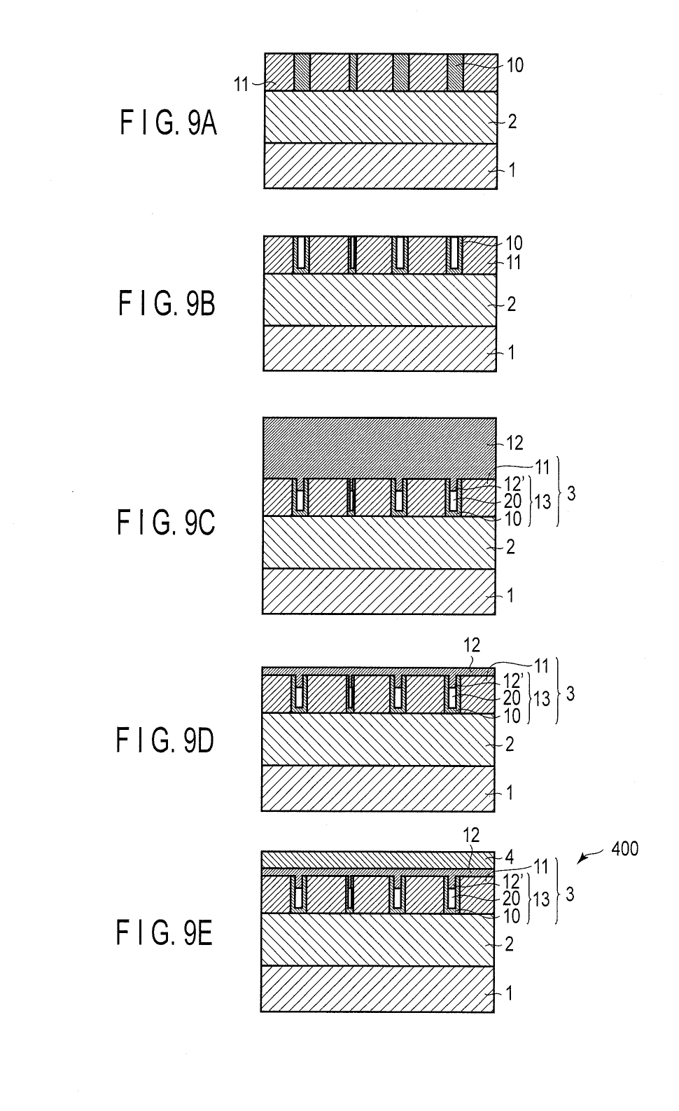

FIGS. 9A, 9B, 9C, 9D, and 9E are views showing an example of a method of manufacturing the magnetic recording medium of Example 4.

As shown in FIG. 9A, a 10-nm-thick MgO underlayer 2 is deposited on a glass substrate 1 by sputtering at an Ar gas pressure of 1 Pa and an RF power of 800 W. While the substrate is heated to 500° C., a 6-nm-thick FePt—C magnetic recording layer is formed on the substrate by sputtering by using Fe, Pt, and C as targets at an Ar gas pressure of 1 Pa and a DC power of 1,000 W. The obtained magnetic recording layer has a granular structure including FePt magnetic grains 11 and a grain boundary formed by a C layer 10 between the magnetic grains 11.

Then, as shown in FIG. 9B, the C layer 10 is partially removed by etching. The C layer 10 can partially be removed by, for example, etching using oxygen plasma. More specifically, RIE is performed for 10 seconds at an oxygen flow rate of 10 sccm, a total pressure of 0.1 Pa, an RF power of 100 W, and a platen power of 10 W. Consequently, the C layer 10 remains from the lower portion of the grain boundary to the side surfaces of the magnetic grains 11, and the interior of the C layer 10 is removed, thereby forming a trench.

Subsequently, as shown in FIG. 9C, a 50-nm-thick SOG layer 12 is deposited on the magnetic grains 11 by spin coating by using a hydrogen silsesquioxane polymer (HSQ) having a molecular weight of 5,000 to 50,000. Since SOG having a relatively large molecular weight is used, an air gap 20 is formed between the C layer 10 and SOG layer 12. Consequently, a grain boundary 13 has the C layer 10, the air gap 20 formed on the C layer 10, and a portion 12′ of the SOG layer buried in a part of the trench via the air gap 20. A magnetic recording layer 3 is obtained by the grain boundary 13 and magnetic grains 11.

As shown in FIG. 9D, a planarizing/thinning process is performed by etching so as to level the upper surface of the SOG layer 12 and leave a 2-nm-thick layer behind on the FePt magnetic grains 11. For example, this etching is performed by RIE using gaseous CF₄.

After that, as shown in FIG. 9E, a 5-nm-thick DLC protective film 4 is formed on the SOG layer 12 by sputtering at an Ar gas pressure of 1 Pa and a DC power of 1,000 W, thereby obtaining a magnetic recording medium 400 according to Example 4.

### Example 5

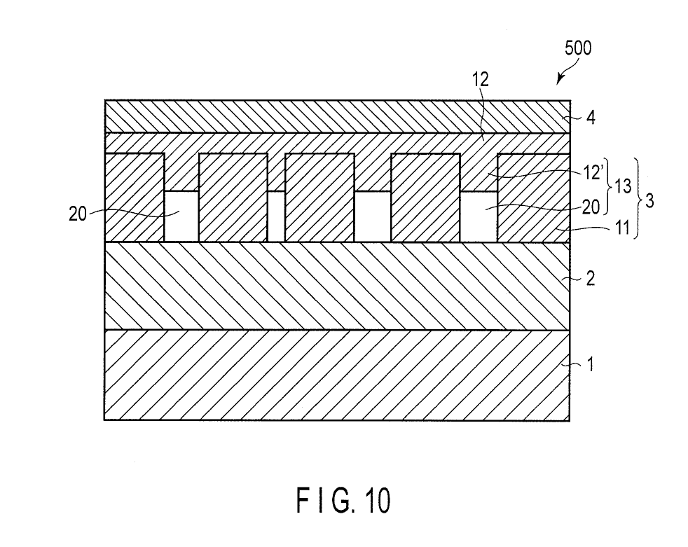

FIG. 10 is a sectional view showing a magnetic recording medium according to Example 5.

A magnetic recording medium 500 according to Example 5 includes a glass substrate 1, and an MgO underlayer 2, magnetic recording layer 3, SiO₂ layer 12, and DLC protective film 4 sequentially formed on the glass substrate 1.

The magnetic recording layer 3 includes magnetic grains 11 made of an FePt alloy having a high magnetic anisotropy, and a grain boundary 13 formed between the magnetic grains 11.

The grain boundary 13 includes an air gap 20, and an SiO₂ layer 12′ formed on the air gap 20 and having a low thermal conductivity. Note that the SiO₂ layer 12 is formed on the air gap 20 and magnetic grains 11 so as to close the air gap 20.

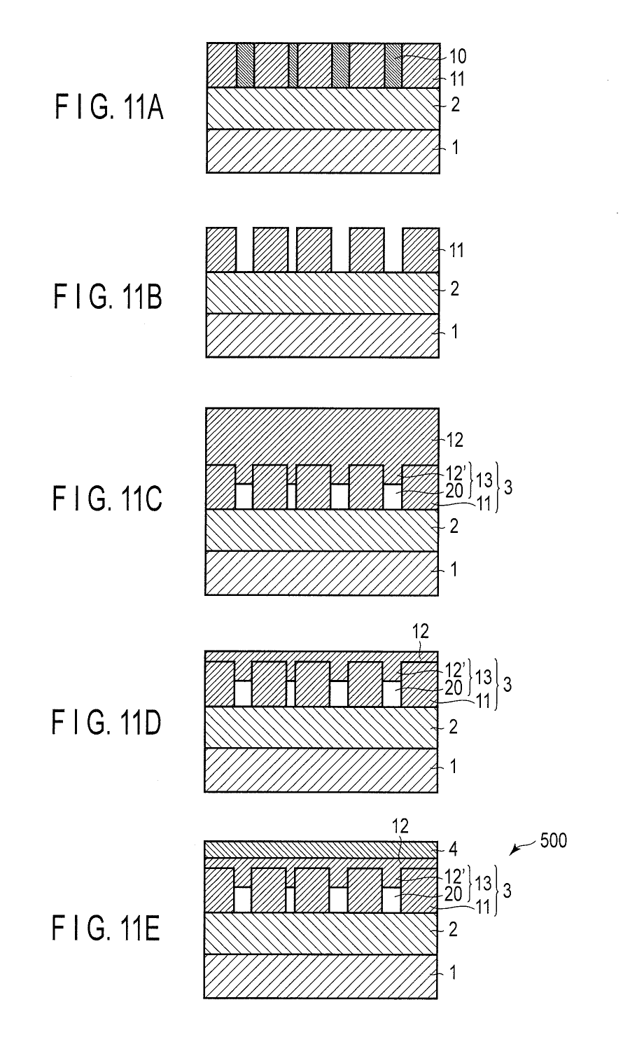

FIGS. 11A, 11B, 11C, 11D, and 11E are views showing an example of a method of manufacturing the magnetic recording medium of Example 5.

As shown in FIG. 11A, a 10-nm-thick MgO underlayer 2 is deposited on a glass substrate 1 by sputtering at an Ar gas pressure of 1 Pa and an RF power of 800 W. While the substrate is heated to 500° C., a 6-nm-thick FePt—C magnetic recording layer is formed on the substrate by sputtering by using Fe, Pt, and C as targets at an Ar gas pressure of 1 Pa and a DC power of 1,000 W. The obtained magnetic recording layer has a granular structure including FePt magnetic grains 11 and a grain boundary formed by a C layer 10 between the magnetic grains 11.

Then, as shown in FIG. 11B, the C layer 10 is removed by etching. The C layer 10 can be removed by, for example, etching using oxygen plasma. More specifically, reactive ion etching (RIE) is performed for 60 seconds at an oxygen flow rate of 20 sccm, a total pressure of 0.1 Pa, an RF power of 100 W, and a platen power of 10 W. Consequently, the C layer in the grain boundary 13 is entirely removed, thereby forming a trench.

Subsequently, as shown in FIG. 11C, a 50-nm-thick spin-on-glass (SOG) layer 12 is deposited on the FePt magnetic grains 11 and trench by spin coating by using a hydrogen silsesquioxane polymer (HSQ) having a molecular weight of 5,000 to 50,000. Since SOG having a relatively large molecular weight is used, an air gap 20 is formed between the bottom of the trench in the grain boundary 13 and the SOG layer 12. Consequently, a grain boundary 13 is formed by the air gap 20, and a portion 12′ of the SOG layer buried on the air gap 20. A magnetic recording layer 3 is obtained by the grain boundary 13 and magnetic grains 11.

As shown in FIG. 11D, a planarizing/thinning process is performed by etching so as to level the upper surface of the SOG layer 12, and leave a 2-nm-thick layer behind on the FePt magnetic grains 11. For example, this etching is performed by RIE using gaseous CF₄.

After that, as shown in FIG. 11E, a 5-nm-thick DLC protective film 4 is formed on the SOG layer 12 by sputtering at an Ar gas pressure of 1 Pa and a DC power of 1,000 W, thereby obtaining a magnetic recording medium 500 according to Example 5.

The recording/reproduction characteristics of the magnetic recording media according to Examples 1 to 5 were evaluated. The recording/reproduction characteristics were measured using a spinstand.

The recording/reproduction characteristics were evaluated at a linear recording density of 1,000 kBPI as a recording frequency condition.

Consequently, the SNRs of Examples 1, 2, 3, 4, and 5 were respectively 11.1, 11.4, 10.8, 11.0, and 11.6 dB. Also, the SNR of Comparative Example 1 was 10.5 dB.

As described in Examples 1 to 5, a structure in which the grain boundary is divided into the first and second grain boundaries and at least one of them suppresses thermal conduction can be formed by forming, between the FePt magnetic grains 11, the grain boundary 13 including the C layer 10 and the SiO₂ layer 12 and/or the air gap 20.

### Example 6

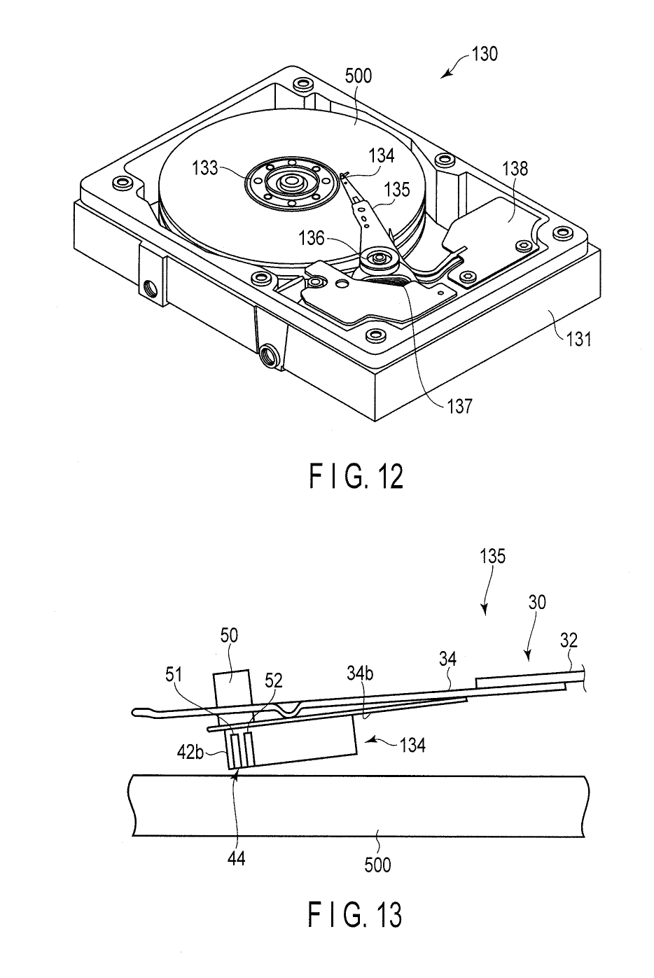

FIG. 12 is a partially exploded perspective view showing an example of a magnetic recording/reproduction apparatus according to Example 6 to which the magnetic recording medium is applicable.

As shown in FIG. 12, a magnetic recording/reproduction apparatus 130 according to the embodiment includes a rectangular boxy housing 131 having an open upper end, and a top cover (not shown) which is fastened to the housing 131 by a plurality of screws and closes the upper-end opening of the housing.

The housing 131 houses, for example, the magnetic recording medium 500 according to Example 5, a spindle motor 133 as a driving means for supporting and rotating the magnetic recording medium 500, a magnetic head 134 for recording and reproducing magnetic signals with respect to the magnetic recording medium 500 by the thermally assisted method, a head gimbal assembly 135 which includes a suspension having a distal end on which the magnetic head 134 is mounted, and supports the magnetic head 134 so that the magnetic head 134 can freely move with respect to the magnetic recording medium 500, a rotating shaft 136 for rotatably supporting the head gimbal assembly 135, a voice coil motor 137 for rotating and positioning the head gimbal assembly 135 via the rotating shaft 136, and a head amplifier circuit board 138.

FIG. 13 is a view showing an arrangement in the periphery of the magnetic head shown in FIG. 12.

As shown in FIG. 13, the magnetic head 134 for recording and reproducing magnetic signals by the thermally assisted method is supported, via a gimbal 34b, by the extended end of a suspension 34 extending from an arm 32 of the head gimbal assembly (HGA) 135. Also, the HGA 135 includes a laser source 50 for emitting a laser beam, as a heating unit for locally heating the perpendicular magnetic recording layer 3 of the magnetic recording medium 500 according to Example 5. The laser source 50 is mounted on the distal end portion of the suspension 34.

Furthermore, a head unit 44 includes a reproduction head 52 and recording head 51 formed on a trailing end 42b of a slider 134 by a thin film process, and is formed as a separated magnetic head.

The temperature of the magnetic recording medium was calculated as a function of the distance from the laser source when heating was performed at 400° C. by using the laser source 50 of the magnetic recording/reproduction apparatus 130.

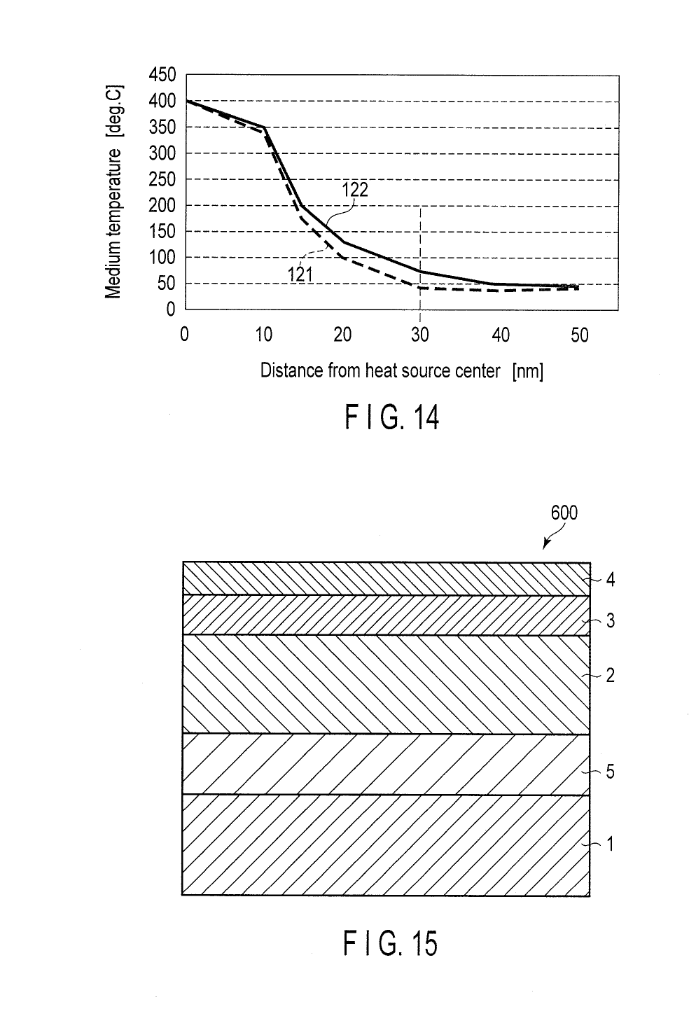

FIG. 14 is a graph showing the relationship between the distance from the laser source and the temperature of the magnetic recording medium.

In FIG. 14, reference numeral 121 denotes data obtained when using the magnetic recording medium according to Example 5; and 122, data obtained when using the magnetic recording medium according to Comparative Example 1 for comparison.

As shown in FIG. 14, when the position was 30 nm from the heat source center, the temperature of Example 5 was lower by 30° C. than that of Comparative Example 1. This indicates that thermal spread between the magnetic grains can be suppressed when using the magnetic recording medium according to the embodiment.

Also, when the values of Examples 1 to 4 were similarly obtained, the effect of suppressing thermal spread between the magnetic grains was found.

### Example 7

FIG. 15 is a sectional view showing a magnetic recording medium according to Example 7.

As shown in FIG. 15, a magnetic recording medium 600 is a magnetic recording medium to be incorporated into a magnetic disk apparatus for thermally assisted recording, and has the same structure as that shown in FIG. 1 except that a heat-sink layer 5 made of, for example, Ag is formed between a glass substrate 1 and MgO underlayer 2.

This heat-sink layer is deposited to have a thickness of 30 nm by sputtering by using Ag as a target at an Ar gas pressure of 1 Pa and a DC power of 1,000 W.

The magnetic recording medium according to Example 7 has the effect of further suppressing thermal spread between the magnetic grains by forming the heat-sink layer 5.

Also, when the magnetic recording/reproduction characteristic was measured in the same manner as in Example 1, the SNR was 13.6 dB.

### Example 8

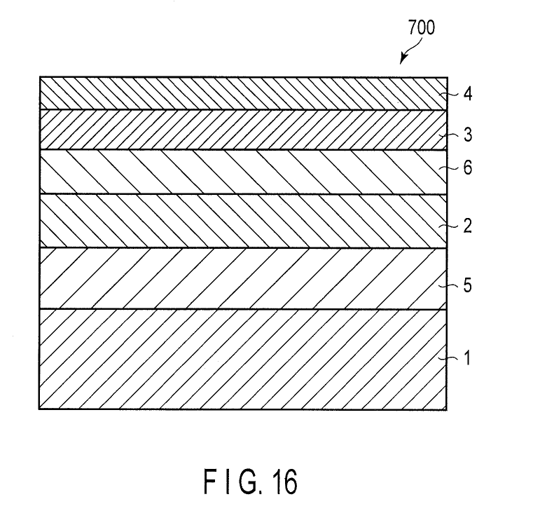

FIG. 16 is a sectional view showing a magnetic recording medium according to Example 8.

As shown in FIG. 16, a magnetic recording medium 700 is a magnetic recording medium to be incorporated into a magnetic disk apparatus for thermally assisted recording, and has the same structure as that shown in FIG. 15 except that a thermal barrier layer 6 made of, for example, ZrO₂ is formed between an MgO underlayer 2 and magnetic recording layer 3.

This thermal barrier layer is deposited to have a thickness of 10 nm by sputtering by using ZrO₂ as a target at an Ar gas pressure of 1 Pa and a DC power of 1,000 W.

The magnetic recording medium according to Example 8 has the effect of further suppressing thermal spread between the magnetic grains by forming the heat barrier layer 6.

Also, when the magnetic recording/reproduction characteristic was measured in the same manner as in Example 1, the SNR was 13.8 dB.

Furthermore, the arrangement of the magnetic recording layer of each of Examples 7 and 8 described above need not be the same as that of Example 1, and can be selected from the arrangements of the magnetic recording layers used in Examples 2 to 5.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic recording medium comprising:
a substrate; and
a magnetic recording layer formed on the substrate, and comprising magnetic grains and a grain boundary formed between the magnetic grains,
wherein the grain boundary comprises a first grain boundary having a first thermal conductivity, and a second grain boundary formed on the first grain boundary and having a second thermal conductivity different from the first thermal conductivity, and at least one of the first grain boundary and the second grain boundary is configured to suppress thermal conduction.

2. The medium of claim 1, further comprising a heat-sink layer between the substrate and the magnetic recording layer.

3. The medium of claim 2, wherein the heat-sink layer contains at least one material selected from the group consisting of silver, copper, gold, and alloys thereof.

4. The medium of claim 2, further comprising a thermal barrier layer between the heat-sink layer and the magnetic recording layer.

5. The medium of claim 4, wherein the thermal barrier layer contains ZrO₂.

6. The medium of claim 1, wherein the magnetic grains are selected from the group consisting of an iron-platinum alloy having an L1₀ structure, a cobalt-platinum alloy having the L1₀ structure, and a multilayered film of cobalt and platinum.

7. The medium of claim 1, wherein each of the first grain boundary and the second grain boundary is selected from a layer made of at least one material selected from the group consisting of carbon, SiO₂, and TiO₂, and an air gap defined by the layer and the magnetic grains.

8. A magnetic recording medium manufacturing method comprising:
forming, on a substrate, a magnetic recording layer including magnetic grains and a grain boundary formed between the magnetic grains and made of a first material; and
forming a trench by removing at least a portion of the grain boundary, and forming, on the trench, a layer made of a second material having a thermal conductivity lower than that of the first material, thereby forming a structure in which the grain boundary is divided into a first grain boundary having a first thermal conductivity and a second grain boundary formed on the first grain boundary and having a second thermal conductivity different from the first thermal conductivity, and at least one of the first grain boundary and the second grain boundary suppresses thermal conduction.

9. The method of claim 8, further comprising forming a heat-sink layer on the substrate before the forming the magnetic recording layer.

10. The method of claim 9, wherein the heat-sink layer contains at least one material selected from the group consisting of silver, copper, gold, and alloys thereof.

11. The method of claim 9, further comprising forming a thermal barrier layer on the heat-sink layer before the forming the magnetic recording layer.

12. The method of claim 11, wherein the thermal barrier layer contains ZrO₂.

13. The method of claim 8, wherein the manufacturing the magnetic recording medium comprises sputtering an FePt—C target or Co, Pt, and C targets.

14. The method of claim 8, wherein each of the first grain boundary and the second grain boundary is selected from a layer made of at least one material selected from the group consisting of carbon, SiO₂, and TiO₂, and an air gap defined by the layer and the magnetic grains.

15. The method of claim 14, wherein the first material is carbon, and the second material is one of SiO₂ and TiO₂.

16. A magnetic recording/reproduction apparatus comprising:
a magnetic recording medium comprising a substrate, and a magnetic recording layer formed on the substrate, and including magnetic grains and a grain boundary formed between the magnetic grains, the grain boundary including a first grain boundary having a first thermal conductivity, and a second grain boundary formed on the first grain boundary and having a second thermal conductivity different from the first thermal conductivity, and at least one of the first grain boundary and the second grain boundary suppressing thermal conduction; and
a magnetic head including a heat source configured to heat the magnetic recording medium.

17. The apparatus of claim 16, further comprising a heat-sink layer between the substrate and the magnetic recording layer.

18. The apparatus of claim 17, wherein the heat-sink layer contains at least one material selected from the group consisting of silver, copper, gold, and alloys thereof.

19. The apparatus of claim 16, wherein the magnetic grains are selected from the group consisting of an iron-platinum alloy having an L1₀ structure, a cobalt-platinum alloy having the L1₀ structure, and a multilayered film of cobalt and platinum.

20. The apparatus of claim 16, wherein each of the first grain boundary and the second grain boundary is selected from a layer made of at least one material selected from the group consisting of carbon, SiO₂, and TiO₂, and an air gap defined by the layer and the magnetic grains.
